(19) United States
(12) Patent Application Publication
(10) Pub. No.: US 2011/0188622 A1
(43) Pub. Date: Aug. 4, 2011

(54) Neutral Particle Generator

(75) Inventor: Oded Shrier, New South Wales (AU)

(73) Assignee: JIDDTEK PTY LTD, Rose Bay, NSW (AU)

(21) Appl. No.: 13/055,997

(22) PCT Filed: Jun. 22, 2009
(86) PCT No.: PCT/AU2009/000800

§ 371 Date: Mar. 31, 2011

Related U.S. Application Data
(60) Provisional application No. 61/085,304, filed on Jul. 31, 2008.

(30) Foreign Application Priority Data
Jul. 31, 2008 (AU) 2008903924

(51) Int. Cl. H05H 3/06

(52) U.S. Cl. 376/108

(57) ABSTRACT

A neutral particle generator is disclosed that includes a container which holds a material in at least a partial plasma state, for example a Deuterium plasma. In one form, a first cathode is positioned within the container and produces a first beam of neutral particles directed away from the first cathode. Optionally, a second cathode is also positioned within the container and produces a second beam of neutral particles directed away from the second cathode, and/or a target is also positioned within the container. In one form, the first cathode and the second cathode are linearly opposed so that the first beam interacts/collides with the second beam resulting in fusion reactions of at least some of the neutral particles, which thereby results in generation of emitted neutrons.

### TECHNICAL FIELD

The present invention generally relates to neutron generating and/or fusion devices and methods for producing neutrons or fusion processes. The present invention also generally relates to devices for and methods of producing one or more beams of neutral particles and applications thereof.

### BACKGROUND

Various types of neutron generators, also known as neutron sources, are presently known. Typically, neutron sources are categorised as either small sized portable neutron sources (for example those that can be handheld and easily moved), medium sized neutron sources (for example particle accelerators occupying a room) or large sized neutron sources, (for example large installations of fusion and fission reactors). Moreover, there are generally considered to be two types of small sized neutron sources. A first type is based on induced or spontaneous fission, however a major disadvantage of this type of small sized neutron source is that such a source cannot be switched off and constantly emits neutrons. A second type of small sized neutron source is based on fusion. This type of neutron source can be switched on and off, which makes these neutron sources or generators suitable for many applications.

Some example applications relying on neutron generators, largely depending on the energy and flux of emitted neutrons, include nuclear and chemical weapon safeguarding inspections, geological analysis, mail bomb detection, neutron radiography, landmine detection, package inspection and medical imaging, to name a few.

The fusion processes of isotopes of Hydrogen, such as Deuterium and Tritium, are well known. In the case of the fusion of Deuterium or Tritium, Helium forms and highly energetic neutrons are emitted.

A known standard neutron generator is shown in FIG. 1. The illustrated tube neutron generator 100 includes an ion source 110, an accelerating region 120 and a cathode 130. Antenna 140, in combination with matching network 150, ionises a gas in cylinder 160. Typically, tube neutron generator 100 is about 10 cm in diameter. Magnets 170 are arranged about cylindrical anode 180 to trap free electrons, which further ionises the gas to produce more ions within cylindrical anode 180. The ions are not trapped in cylindrical anode 180 but are attracted to exit cathode 190, which has a relatively small aperture for the ions to exit cylindrical anode 180 and to enter accelerating region 120. Accelerating region 120 may have an arrangement of further cathodes to gradually increase the energy of the ion beam exiting cylindrical anode 180 and also to focus the ion beam to strike target 130, which is typically an accelerating cathode arrangement connected to a high voltage power supply. Normally, cathode target 130 is biased with more than 100 kV, and in many design configurations it is therefore necessary to cool target cathode 130, for example with a water cooling system. Cathode target 130 is electrically biased and normally made from metal with a surface thin film enriched with fuel material for assisting fusion reactions. Ions striking cathode target 130 cause fusion reactions resulting in emission of neutrons.

Inertial Electrostatic Confinement (IEC) is a known technique for confining ions of a plasma using an electrostatic field, often with the goal of achieving controlled nuclear fusion. Typically, a spherical or cylindrical geometry is used to create an electrostatic field that accelerates ions radially inward to dramatically increase ion density and energy in a central region of an IEC device. An example IEC cylindrical-type device is the neutron generator sold by NSD-Fusion GmbH of Germany. The NSD-Fusion GmbH neutron generator uses a cylindrical grid cathode surrounded by a cylindrical anode. Ions are attracted to the cylindrical grid cathode and can pass inside the cylindrical cathode via a grid surface. NSD-Fusion GmbH asserts that ions are trapped within a central region of the cylindrical grid cathode resulting in ion density build-up in this region, thereby resulting in fusion due to collisions of trapped ions within the cylindrical grid cathode. Neutrons are emitted as a result of the fusion reactions occurring within the cylindrical grid cathode. Thus, in the NSD-Fusion GmbH neutron generator, neutrons are produced as a result of confined ions colliding with background plasma within the cylindrical grid cathode. No solid target of fusion material is used.

Disadvantages of tube neutron generators include: a relatively complex ion source requiring a magnetic field arrangement; a requirement to operate at relatively low background gas pressure (for example a pressure of about 2 mTorr) to allow relatively uninhibited acceleration of ions in the accelerating region; and a requirement for cooling of the target. The applicant also believes that neutron generators based on IEC techniques using a spherical or cylindrical grid type of cathode, such as the NSD-Fusion GmbH neutron generator, have inherent disadvantages, such as relying on an ability to confine ions in a central region of the devices and relying on ion-background gas collisions to produce fusion reactions.

There is a need for a neutron generating device or method for generating neutrons, and/or a device or method for producing one or more beams of neutral particles, having various applications, which addresses or at least ameliorates one or more problems inherent in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### BRIEF SUMMARY

In a first broad form, the present invention provides a neutron generator or source. In a second broad form, the present invention provides a method of generating neutrons. In a third broad form, the present invention provides a neutral particle generator or source. In a fourth broad form, the present invention provides a method of generating neutral particles.

In a particular form, a neutral atomic, molecular and/or particle beam is generated, produced or created which can collide with one or more of a background gas/plasma, a solid target and/or a second neutral atomic, molecular and/or particle beam. In other example forms, no collision of a generated neutral atomic, molecular and/or particle beam is required for some applications.

According to a first example form, there is provided a neutral particle generator, comprising: a container for substantially containing a material in at least a partial plasma state; a first cathode for producing a first beam of neutral particles; and, a second cathode for producing a second beam of neutral particles. Preferably, though not necessarily, the first cathode and the second cathode are positioned so that, in operation, the first beam interacts with the second beam thereby generating neutrons.

In a particular non-limiting example, at least part of the container acts as an anode.

In a further particular example, the first beam and the second beam are substantially directed beams.

In a further particular example, the first beam and the second beam include neutral atoms, molecules and/or particles of the material.

In another example form, the container contains more than one material in at least partial plasma states, the first beam comprised of neutral particles of the more than one material, and the second beam comprised of neutral particles of the more than one material.

Optionally, but not necessarily, the material is at least partially Hydrogen, Deuterium, Tritium or a mixture thereof

According to yet further optional aspects, provided by way of example only:
the first cathode and/or the second cathode are hollow and are provided with at least one aperture;
the first cathode and/or the second cathode are provided with two apertures;
the first cathode and/or the second cathode have a geometry selected from the group consisting of a frustum, a cylinder, an ellipsoid, and a spheroid;
the first cathode and/or the second cathode have an asymmetric geometry;
the first cathode and/or the second cathode are a hollow truncated cone;
the first cathode and/or the second cathode are a hollow conical bifrustum; and/or,
the second cathode is of the same geometry as the first cathode.

In a further example, exterior surfaces of the first cathode and the second cathode are provided with electrical insulation. Optionally, the electrical insulation is ceramic, such as a ceramic sleeve.

Preferably, the pressure of the gaseous material in the container is in the range of about 1 to a few hundred mTorr.

In a particular example form, the first cathode and the second cathode are positioned to be linearly opposed.

According to a further example form, there is provided a neutral particle generator further including a plurality of a further cathodes for producing further beams of neutral particles of the material, each further beam directed away from each respective further cathode from which it originates; wherein, the first cathode, the second cathode and the further cathodes are positioned in a substantially circular or spherical arrangement; and wherein, the first beam, the second beam and the further beams are directed towards a central region of the circular or spherical arrangement.

According to a second example form, there is provided a neutral particle generator, comprising: a container for substantially containing a material in at least a partial plasma state; a cathode for producing a beam of neutral particles, the beam directed away from the cathode; and, a target, positioned within the container. Preferably, the cathode and the target are positioned so that, in operation, the beam is directed to collide with the target. In particular example applications, the collision of the beam with the target can be used to generate neutrons, to coat the surface of the target with the particles or to etch the surface of the target using the particles.

Preferably, though not necessarily, the target is not electrically biased with respect to the cathode. Also preferably, though not necessarily, the target includes a surface region enriched with fusion reaction enhancing material, for example Deuterium and/or Tritium atoms.

In accordance with a further optional embodiment, the neutral particle generator is provided to also include a second cathode for producing a second beam of neutral particles, the second beam directed away from the second cathode; wherein, the second cathode and the target are positioned so that, in operation, the second beam is directed to collide with the target.

In accordance with a further optional embodiment, the neutral particle generator is provided to include the second cathode for producing a second beam of neutral particles, the second beam directed away from the second cathode; a second target, positioned within the container; wherein, the second cathode and the second target are positioned so that, in operation, the second beam is directed to collide with the second target.

According to a third example form, there is provided a neutral particle generator, comprising: a container for substantially containing a material in at least a partial plasma state; a hollow cathode having at least one aperture and positioned within the container; wherein, in operation, when the hollow cathode is negatively biased a beam of neutral particles of the material is produced, the beam directed away from the at least one aperture.

Preferably, the beam includes neutral atoms, molecules and/or particles of the material.

According to a fourth example form, there is provided a method of generating neutrons, comprising:
using a hollow cathode with at least one aperture to create ions of a plasma material within an internal region of the cathode, thereby forming a virtual anode within the cathode;
allowing at least some of the ions to be repelled by the virtual anode and to undergo a charge exchange process with the plasma material within the hollow cathode, thereby forming a beam of neutral particles directed away from the at least one aperture; and
causing the beam of neutral particles to collide with other particles, thereby resulting in fusion reactions between at least some of the neutral particles of the beam and at least some of the other particles to produce neutrons.

In a particular but non-limiting form, the step of creating ions of the plasma material within the internal region results in the ions bombarding an inner surface of the hollow cathode and increasing the electron density within the cathode. In consequence, further ionization takes place and a relatively high ion density is formed at or near the centre of the hollow cathode, herein referred to as a “virtual anode”.

Optionally, the other particles are part of a second beam of neutral particles produced by the same method. Also optionally, the other particles are part of a target material. Also optionally, the other particles are part of the plasma material.

According to a fifth example form, there is provided a method of generating neutral particles for coating materials, comprising: using a hollow cathode with at least one aperture to create ions of a plasma material within an internal region of the cathode, thereby forming a virtual anode within the cathode; allowing at least some of the ions to be repelled by the virtual anode and to undergo a charge exchange process with the plasma material within the hollow cathode, thereby forming a beam of neutral particles directed away from the at least one aperture; and causing the beam of neutral particles to collide with a surface, thereby coating or etching the surface with the neutral particles.

According to a sixth example form, there is provided a method of generating an electron beam, comprising: using a hollow cathode with at least one aperture to create ions of a plasma material and electrons within an internal region of the cathode, whereby the ions form an electric potential that repels the electrons, thereby forming a beam of electrons directed away from the at least one aperture.

### BRIEF DESCRIPTION OF FIGURES

Example embodiments should become apparent from the following description, which is given by way of example only, of at least one preferred but non-limiting embodiment, described in connection with the accompanying figures.

FIG. 1 (prior art) illustrates a standard tube neutron generator;

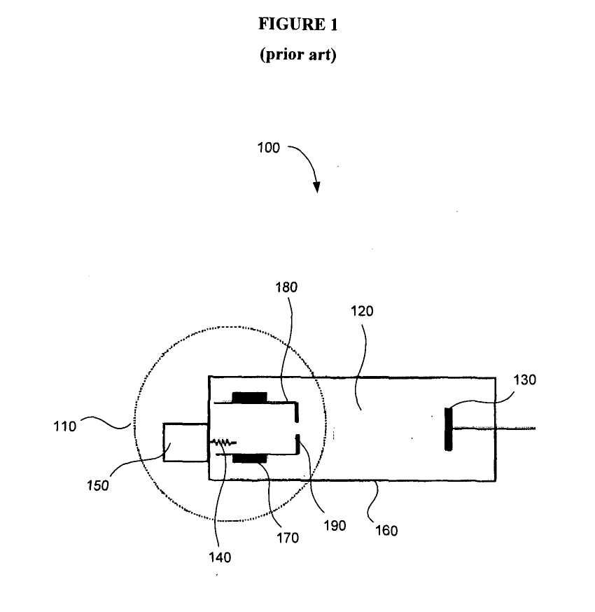

FIG. 2 illustrates a cross-sectional view of a double cathode neutral particle generator;

FIG. 3 illustrates a cross-sectional view of a multiple cathode neutral particle generator;

FIG. 4 illustrates a cross-sectional view of a circular or spherical multiple cathode neutral particle generator;

FIG. 5 illustrates a cross-sectional view of a double cathode—single target neutral particle generator;

FIG. 6 illustrates a cross-sectional view of a single cathode—double target neutral particle generator;

FIG. 7 illustrates a cross-sectional view of a multiple cathode—multiple target neutral particle generator.

### PREFERRED EMBODIMENT

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

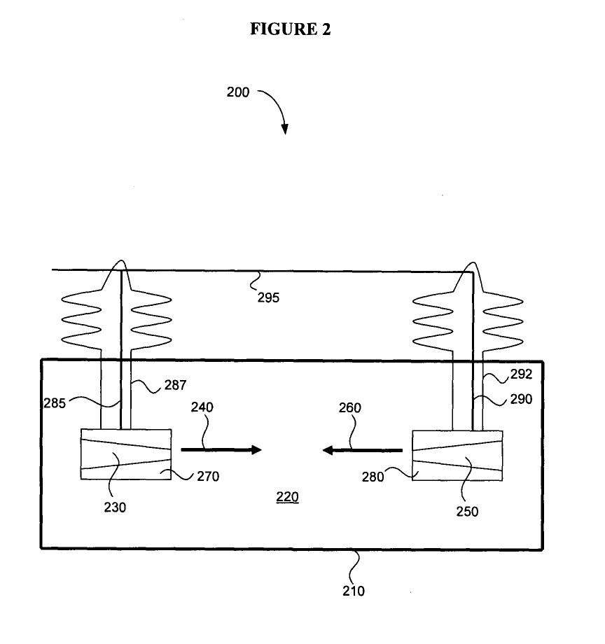

Referring to FIG. 2 there is illustrated a neutral particle generator 200, which can be used as a neutron generator. A container 210, or other type of reaction chamber or enclosure, substantially contains or holds a gaseous material 220 in at least a partial plasma state within container 210. It should be noted that container 210 can be a variety of shapes or geometries, and may be a component part or section of a larger enclosure or multiple enclosures or regions.

Material 220 is preferably a partially or substantially fully ionised gas or mixture of gases, so that material 220 can include atoms, molecules, chemicals, isotopes, ions, electrons, etc., individually or in any combination, in a plasma state. One or more different types of materials, such as different chemical elements, isotopes or molecules can be utilised.

A first cathode 230 is positioned within container 210. First cathode 230 is used to produce a first beam 240 of neutral particles of material 220, which should be taken to include the neutral particles being otherwise derived from material 220, such as if the neutral particles are a product of a chemical and/or physical reaction involving reactant particles of material 220.

As illustrated, first beam 240 of neutral particles is directed away from first cathode 230. Similarly, second cathode 250 is positioned within container 210 and produces second beam 260 of neutral particles of, or derived from, material 220. Also as illustrated, second beam 260 is directed away from second cathode 250. First cathode 230 and second cathode 250 are positioned so that, when generator 200 is in operation, first beam 240 interacts with second beam 260, for example by collision of at least some of the neutral particles from each beam 240, 260. Interaction of beams 240, 260 thereby results in neutrons being generated as a consequence of fusion reactions occurring due to collisions of the neutral particles of the beams 240, 260. According to alternate embodiments, it is not necessary that beams 240, 260 be made to collide.

At least part of container 210 is optionally used as one or more anodes. In one form, all of container 210 may act as an anode. This can assist in repelling ions from the walls of container 210 and attracting electrons to sustain the above-described physical processes occurring within the cathode. Due to the geometry of first cathode 230 and second cathode 250, and the physical processes occurring within the cathodes 230, 250, first beam 240 and second beam 260 are formed as substantially directed beams. First beam 240 and second beam 260 include neutral atoms and/or molecules of, or derived from, material(s) 220.

In a particular example, material 220 is at least partially Hydrogen, Deuterium, Tritium, or a mixture thereof. Thus, container 210 can contain more than one type of material 220 in at least partial plasma states (e.g. plasma/gas mixes), so that first beam 240 may be comprised of neutral particles of more than one material, and second beam 260 may likewise be comprised of neutral particles of more than one material. It should be noted that first beam 240 and second beam 260 may be comprised of neutral particles of different isotopes of particular chemical elements and/or molecules.

In a particular example, container 210 (i.e. chamber or reactor) is a sealed cylindrical vacuum container made from stainless steel. It should be appreciated that a wide variety of materials, for example other metals, can be used. The dimensions of container 210 can be varied widely, however, a preferred chamber length may be in the range of 40 to 60 cm and a preferred chamber diameter may be in the range of 15 to 20 cm.

The gas used to fill container 210 may be pure Deuterium. However, a mixture of Deuterium and Tritium, for example in the ratio 1:1, may be more preferable so as to increase fusion reaction rates. A preferred, but not necessarily required, background gas pressure is in the range of 1 to a few hundred mTorr, for example 100-400 mTorr. However, it should be noted that generator 200 can be operated outside of this pressure range.

First cathode 230 and second cathode 250 are made from stainless steel, although a wide variety of other materials are possible, for example Titanium or other metals could be used. First cathode 230 and second cathode 250 both have a geometry of a truncated cone which is symmetrical about a longitudinal axis, and is open on both ends of the truncated cone, thereby forming an aperture at each end of the cones. As a specific but non-limiting example, the length of cones 230, 250 is preferably in the range of 5 to 10 cm, where the smaller diameter at a truncated end is in the range of 1 to 2 cm, and where the larger diameter at the other truncated end is in the range of 3 to 5 cm. First cathode 230 and second cathode 250 are placed apart, for example at least 5 cm away from the walls of container 210 and preferably at least 15 cm apart from each other. First cathode 230 and second cathode 250 are hollow and the wall thickness of the cathodes 230, 250 could be varied widely, but may be 1 mm in thickness by way of example.

It should be noted that a wide variety of geometries of cathodes 230, 250 can be used, the present invention is not limited to use of a truncated cone (whether having a circular or polygonal base, or whether right angle or oblique) or other specific geometry. The cathodes 230, 250 can thus have an asymmetric geometry. Other types of optional geometries include a first cathode and/or a second cathode being hollow and in the shape of a frustum, a cylinder, an ellipsoid and/or a spheroid. In a double or multiple cathode device, different cathodes are preferably of the same geometry, but this is not necessary and different cathodes may have different geometries.

The exterior surfaces of first cathode 230 and second cathode 250 are provided with electrical insulation. For example, ceramic sleeve 270 is used to electrically isolate the outside of first cathode 230, and ceramic sleeve 280 is used to electrically isolate the outside of second cathode 250. Ceramic sleeves 270, 280 electrically isolate the exterior surfaces of cathodes 230, 250 from material 220 within container 210. As illustrative examples, ceramic sleeves 270, 280 can be cylindrically shaped externally and machined on the inside so as to receive cone shaped cathodes 230, 250, or can be cylindrically shaped internally to contain a cylindrically shaped cathode, where a hollow cone is machined into the cathode. Electrical feed-throughs 285, 290 pass through ceramic sleeves 270, 280 to attach to cathodes 230, 250, respectively. Electrical feed-throughs 285, 290 are also fitted with ceramic insulation 287, 292, respectively, although a variety of other forms of insulating material could be used. Electrical feed-throughs 285, 290 pass outside of container 210 to attach to high voltage electrical connection 295.

The required voltage and current are supplied externally from container 210, for example using a pulsed or continuous high voltage power supply. A wide range of voltages and currents can be supplied depending on materials used and specific requirements. By way of example, the voltage applied to cathodes 230, 250 can be in the range of −40 to −100 kV and the current supplied to cathodes 230, 250 can be in the range of milli to thousands of amperes. Generator 200 can be operated in continuous or non-pulsed mode, in which case the supplied current is usually, but not necessarily, of the order of tens of milli-amps.

In a particular example, intended to be merely illustrative and not limiting to the scope of the present invention, Deuterium can be introduced to container 210 at a background pressure of about 10 mTorr. The applied voltage to cathodes 230, 250 can be 20 kV and the supplied continuous current can be 40 mA. These parameters were found to produce an emitted neutron count of at least the order of 10⁴ to 10⁵ neutrons/second. Using a mixture of Deuterium and Tritium gases can increase neutron counts by about two orders of magnitude. Using higher voltages and currents it is expected neutron generator 200 can produce of the order of about 10¹¹ and about 10¹⁴ neutrons/second for continuous and pulsed modes, respectively.

It will be appreciated by the person skilled in the art that generator 200 does not require a meshed or grid type cathode, or to be surrounded with a larger spherical or cylindrical anode mesh or grid, as is typically required in Inertial Electrostatic Confinement (IEC) devices. IEC methods rely on the assumption that ions from a background plasma are attracted to a spherical or cylindrical mesh or grid cathode from all directions, so that the ions are accelerated towards an inner region of the cathode and undergo collisions within the cathode resulting in fusion reactions. This IEC method relies on confinement of the ions within the mesh or grid cathode. In marked contrast, generator 200 is not based on the typical IEC method. In generator 200 it is believed ions are repelled from a virtual anode region within cathodes 230, 250 and undergo a charge exchange process with the background gas, resulting in cathodes 230, 250 emitting beams 240, 260 of neutral particles (which is not dependent on a mesh or grid cathode and is not necessarily dependent on the particular shape of cathodes 230, 250). This allows generator 200 to operate as a multiple cathode device directing one or more beams of neutral particles at each other or at a specified solid target. This advantageously provides for beam-beam and beam-target fusion reactions resulting in emission of neutrons.

The process occurring to produce beams 240, 260 of neutral particles is now discussed. When generator 200 is switched on, ions of material 220 are attracted to the inner surfaces of cathodes 230, 250 due to electrostatic attraction. Electrons are ejected from the inner surfaces of cathodes 230, 250 due to the ions bombarding the inner surfaces. This results in a higher density of ionized gas being formed within the cathodes 230, 250. A build-up of ions within the hollow regions of cathodes 230, 250 results in a virtual anode of some extent forming within cathodes 230, 250 due to dynamic self-organisation of the ions and electrons.

This results in a proportion of ions within cathodes 230, 250 being repelled due to the internal virtual anodes within physical cathodes 230, 250. At least some of the repelled ions are directed towards the smaller diameter aperture of cathodes 230, 250. These precursor ions undergo a process of charge exchange due to collisions with neutral particles of background material 220 that have not been ionised. This charge exchange process results in an energetic neutral particle of material 220 being produced which travels in the same direction as the incident precursor ion, which is away from the cathode.

As the resulting energetic neutral particle is not affected by the electric field of the cathode or the virtual anode, the energetic neutral particle continues as a neutral beam away from the cathode. It is possible that the actual charge exchange collision could occur within the cathode or within the vicinity of an aperture of the cathode, which might be exterior to the cathode. Thus, ions are generated and/or repelled from an interior region of the cathode and accelerated outwards away from the cathode centre, whilst the ions are within the cathode. A charge exchange process then occurs which results in a beam of neutral particles continuing uninhibited, electrically, away from the cathode. This exemplifies a different method of operation of generator 200 from IEC devices.

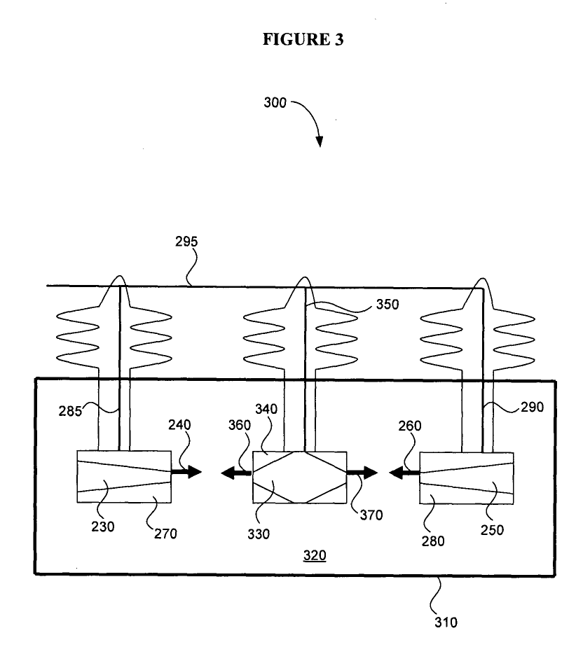

Referring to FIG. 3, there is illustrated a neutral particle generator 300 with multiple cathodes. Container 310 substantially contains gaseous material(s) 320 in at least a partial plasma state, similarly as described for material(s) 220. First cathode 230 and second cathode 250, or similar devices, can be utilised. Additionally, a further cathode 330, having insulation 340 is used. Electrical feed-through 350 which connects to high voltage line 295 is provided.

In the example illustrated, further cathode 330 is placed between first cathode 230 and second cathode 250. Further cathode 330 may be formed of hollow truncated cones placed back to back, or alternatively may be integrally formed as a hollow conical bifrustum. Further cathode 330 operates similarly as described for cathodes 230, 250. This results in further beams 360, 370 of neutral particles of, or derived from, material 320. Beam 360 of neutral particles is thus directed to interact with first beam 240 and beam 370 of neutral particles is thus directed to interact with second beam 260. Cathodes 230, 250 and 330 are positioned substantially linearly for interaction/collision of the respective beams of neutral particles. As previously discussed, collision of neutral beams can be used to generate neutrons.

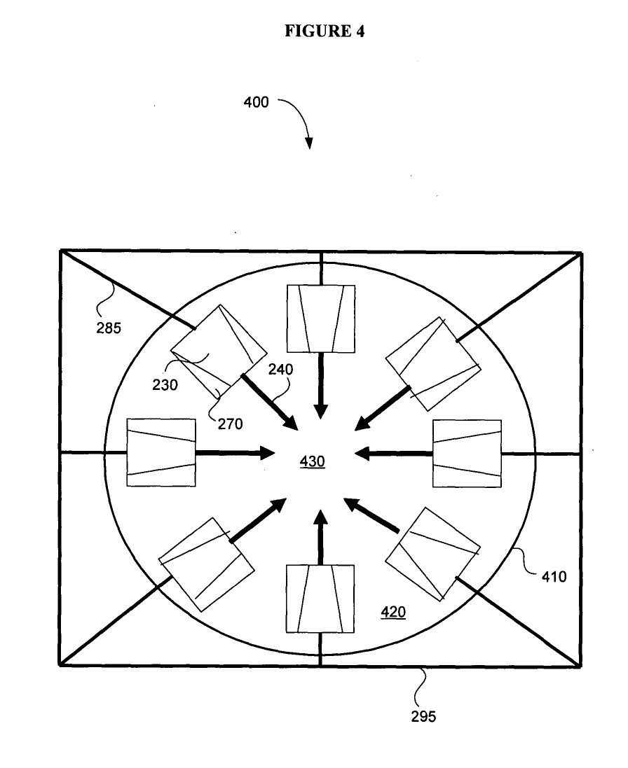

Referring to FIG. 4, there is illustrated a spherically or circularly arranged multiple neutral beam generator 400. A plurality of cathodes 230 can be arranged in a two-dimensional circular configuration, or alternatively a three-dimensional spherical configuration. The plurality of cathodes 230 are arranged within container 410, that likewise may be of cylindrical or spherical extent. The plurality of electrical feed-throughs 285 connect each of the plurality of cathodes 230 to high voltage line 295. A plurality of beams 240 of neutral particles are formed of, or derived from, one or more materials 420 contained within container 410.

The plurality of beams of neutral particles are directed towards central region 430 where the beams 240 interact/collide resulting in a higher proportion of fusion reactions and consequently an increased rate of neutron production. Pairs of the plurality of cathodes 230 are preferably diametrically opposed for good alignment of collisions of the neutral particle beams.

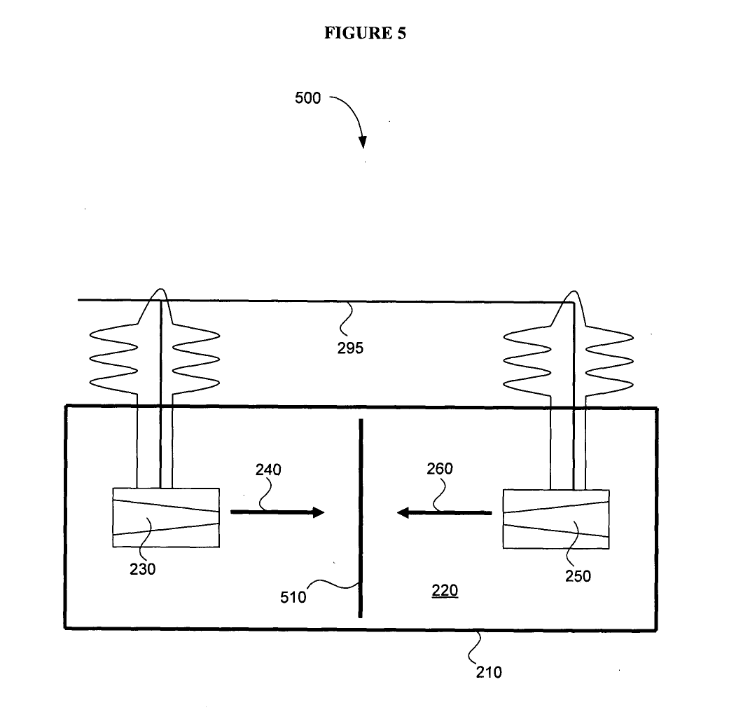

Illustrated in FIG. 5 is a neutral particle generator 500 that includes a target 510. Similarly as for neutral particle generator 200, first cathode 230 produces first beam 240 of neutral particles and second cathode 250 produces second beam 260 of neutral particles. Between first cathode 230 and second cathode 250 is positioned target 510, so that first beam 240 strikes target 510 from a first side and second beam 260 strikes target 510 from a second side.

Preferably, target 510 is a solid target and is substantially, though not necessarily, planar. Target 510 can be enriched or coated with fusion assisting or fusing materials, for example Deuterium and/or Tritium, on one or both surfaces. Beams 240, 260 collide with respective surfaces of target 510 and the nuclei of beams 240, 260 can undergo a fusion reaction with nuclei of target 510.

Importantly, it should be noted that preferably target 510 is not electrically biased with respect to cathodes 230, 250. By providing a configuration where target 510 does not need to be biased this provides a significant advantage over known devices where ions are required to be accelerated to strike an electrically biased electrode which is used as the target. In device 500, as target 510 is electrically unbiased this simplifies the construction of device 500 and reduces possible complications such as electric arcing to target 510 if high voltages are required to be used. This also further simplifies the construction of device 500 as there is no need to use more than one power supply or complicated electronic devices to split supplied voltages between different cathodes and targets.

According to an alternate application, device 500 can be used to coat or etch target 510 rather than generate neutrons. Particles from beams 240, 260 can be used to coat the surface of target 510, or be otherwise embedded within target 510.

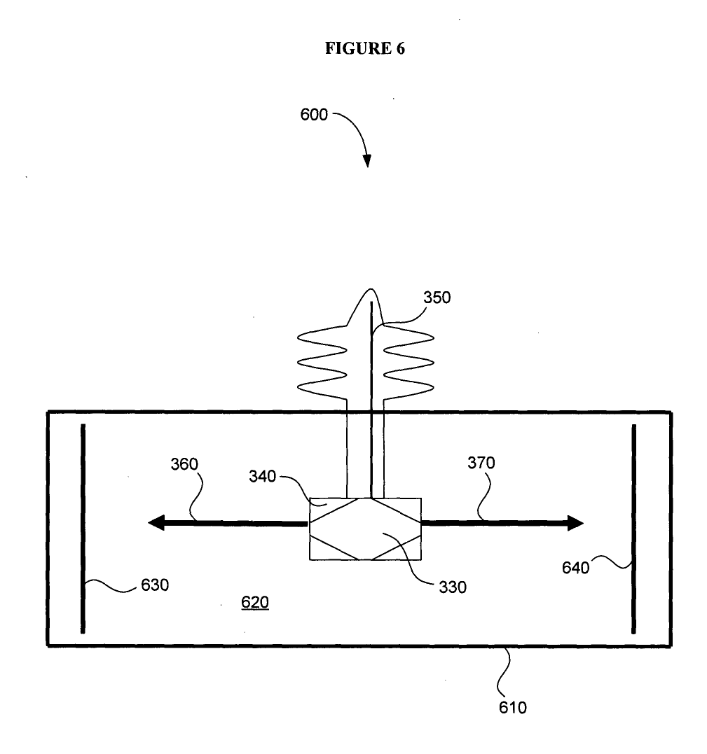

Referring to FIG. 6, there is illustrated a neutral particle generator 600 having multiple targets. Cathode 330 can be used that is positioned within container 610 holding one or more materials 620 in at least a partial plasma state. As previously described, cathode 330 generates further beams 360, 370 of neutral particles of, or derived from, material 620. Beam 360 is directed to collide with target 630 and beam 370 is directed to collide with target 640. Targets 630, 640 may be similar to target 510 as previously described. Targets 630, 640 can be used to generate neutrons or can be coated with or etched by particles from beams 360, 370.

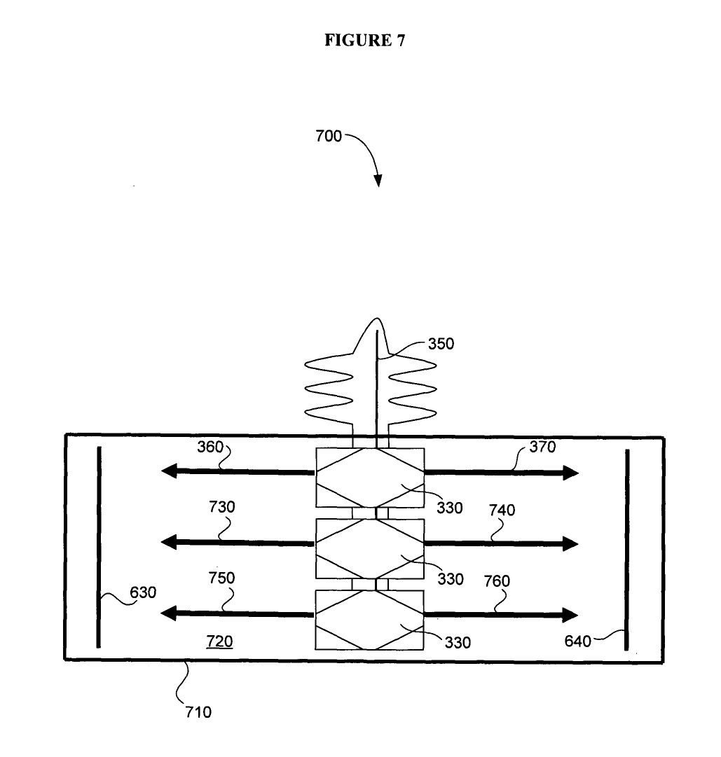

Referring to FIG. 7, there is illustrated a neutral particle generator 700 having multiple cathodes 330 and multiple targets 630, 640 within container 710 for containing material(s) 720. This arrangement results in multiple beams 360, 370, 730, 740, 750, 760 directed to collide with either target 630 or target 640. By having multiple beams colliding with multiple targets the rate of generation of emitted neutrons can be substantially increased. It should be noted that a wide variety of other configurations involving a plurality of different shapes of cathodes and a plurality of targets can be used with a wide variety of different shapes of containers.

It should be noted that the neutral particle or neutron generator devices hereinbefore described can be scaled up to be substantially larger, for example room sized, devices. In particular examples, the cathodes could have diameters of the order of tens of centimetres to produce higher rates of emitted neutrons, although appropriate shielding, cathode cooling systems and high current capacity power supplies would be required.

Also, it should be noted that a single cathode generating a beam of neutral particles can be used for neutral particle coating, etching and/or implantation of surfaces. In this configuration of a single cathode the device can be considered to be a neutral particle generator for coating or etching surfaces. The neutral particle generator contains a hollow cathode having at least one aperture which results in a beam of neutral particles of a background material being produced, the beam being directed away from the at least one aperture. In these situations, where a fusion reaction and subsequent neutron production is not desired, a wide variety of different background gases can be used, for example gases that are useful to coat certain materials.

In other embodiments, a variety of applications are possible for the device when being used to produce a beam of neutral particles, for example as an ion/neutral particle gun or as a thruster with space propulsion or station keeping applications.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1-37. (canceled)

38. A neutral particle generator, comprising:
a container for substantially containing a material in at least a partial plasma state;
a first cathode, positioned within the container, for producing a first beam of neutral particles of the material, the first beam directed away from the first cathode; and,
a second cathode, positioned within the container, for producing a second beam of neutral particles of the material, the second beam directed away from the second cathode.

39. The generator as claimed in claim 38, wherein the first cathode and the second cathode are positioned so that, in operation, the first beam interacts with the second beam thereby generating neutrons.

40. The generator as claimed in claim 38, wherein at least part of the container acts as an anode.

41. The generator as claimed in claim 38, wherein the first beam and the second beam are directed beams.

42. The generator as claimed in claim 38, wherein the first beam and the second beam include neutral atoms and/or molecules of the material.

43. The generator as claimed in claim 38, wherein the material is at least partially Hydrogen, Deuterium, Tritium or a mixture thereof.

44. The generator as claimed in claim 38, wherein the first cathode and the second cathode are hollow and are provided with at least one aperture.

45. The generator as claimed in claim 38, wherein the first cathode or the second cathode have a geometry selected from the group consisting of a frustum, a cylinder, an ellipsoid, and a spheroid.

46. The generator as claimed in claim 38, wherein the first cathode or the second cathode have an asymmetric geometry.

47. The generator as claimed in claim 38, further including a plurality of a further cathodes, positioned within the container, for producing further beams of neutral particles of the material, each further beam directed away from each respective further cathode from which it originates;
wherein, the first cathode, the second cathode and the further cathodes are positioned in a substantially circular arrangement;
and wherein, the first beam, the second beam and the further beams are directed towards a central region of the circular arrangement.

48. The generator as claimed in claim 38, wherein a target material is positioned between the first cathode and the second cathode.

49. A neutral particle generator, comprising:
a container for substantially containing a material in at least a partial plasma state;
a cathode which is hollow and has at least one aperture, positioned within the container, wherein in operation the cathode is negatively biased and produces a beam of neutral particles of the material, at least part of the beam of neutral particles originating within the cathode and directed away from the at least one aperture of the cathode.

50. The generator as claimed in claim 49, wherein the cathode and a target are positioned so that, in operation, the beam is directed to collide with the target.

51. The generator as claimed in claim 49, wherein the beam undergoes collisions with the material outside of the cathode.

52. The generator as claimed in claim 50, wherein neutrons are generated as a result of the collisions.

53. The generator as claimed in claim 49, wherein the cathode includes two apertures and produces two separate beams of neutral particles, each beam directed away from a respective aperture of the cathode.

54. The generator as claimed in claim 50, wherein the target includes a surface region enriched with Deuterium and/or Tritium atoms.

55. The generator as claimed in claim 49, wherein the cathode is tapered at one or both ends.

56. The generator as claimed in claim 50, also including a second cathode which is hollow and produces a second beam of neutral particles of the material, wherein, the second cathode and the target are positioned so that, in operation, the second beam of neutral particles is directed to collide with the target.

57. A method of generating neutrons, comprising:
using a cathode which is hollow and has at least one aperture to create ions of a plasma material within an internal region of the cathode, thereby forming a virtual anode within the cathode;
allowing at least some of the ions to be repelled by the virtual anode and to undergo a charge exchange process with the plasma material within the cathode, thereby forming a beam of neutral particles directed away from the at least one aperture; and
causing the beam of neutral particles to collide with other particles, thereby resulting in fusion reactions between at least some of the neutral particles of the beam and at least some of the other particles to produce neutrons.
